(19) United States
(12) Patent Application Publication
(10) Pub. No.: US 2025/0131294 A1
(43) Pub. Date: Apr. 24, 2025

(54) Processing System, Processing Unit and Processing Method for Processing Object Detection Results Based on Sensor Visibilities

(71) Applicant: Robert Bosch GmbH, Stuttgart (DE)

(72) Inventors: Marc Patrick Zapf, Reutlingen (DE); Jia Hu, Suzhou (CN); Jinyao Liang, Shanghai (CN); Joachim Boerger, Stuttgart (DE)

(21) Appl. No.: 18/687,572

(22) PCT Filed: Aug. 18, 2022
(86) PCT No.: PCT/EP2022/073041

§ 371 Date: Feb. 28, 2024

(30) Foreign Application Priority Data
Sep. 10, 2021 (CN) 202111059391.0

(51) Int. Cl. G06N 5/04

(52) U.S. Cl. CPC G06N 5/04

(57) ABSTRACT

A processing system, a processing unit and a processing method for processing object detection results based on sensor visibilities are provided. The processing unit includes (i) an acquisition module configured to acquire sensor data that is output when one or more sensors detect an ambient environment, (ii) a preprocessing module configured to calculate a set of detection results based on the acquired sensor data, wherein each detection result contains a detection object and the position information thereof, (iii) a creation module configured to create a visibility map based on the acquired sensor data and the calculated detection results, wherein the visibility map comprises a plurality of grid cells of the ambient environment and the visibility probabilities of the grid cells, (iv) an assignment module configured to assign the confidences of the detection results based on the visibility probabilities of grid cells associated with the detection objects of the detection results in terms of position, and (v) a decision-making module configured to determine whether to remove the detection results from the set of detection results based on the confidences of the detection results and a threshold predetermined for the set of detection results.

### TECHNICAL FIELD

The present invention generally relates to a technical solution for processing object detection results, in particular to a technical solution for processing object detection results based on sensor visibilities.

### BACKGROUND ART

Sensor-based object detections play an important role in a networking system and they can provide solutions for many problems in production and life. Such applications include intelligent traffic, smart cities, smart health systems, intelligent buildings and intelligent environments. However, sensor-based object detections still face challenges. For example, object detection results are obtained by calculation based on sensor data output from sensors such as camera and radar. In this way, it is possible that a detection object includes a false positive, that is to say, an object detection system outputs a detection result that an object exists in a position, but the real fact is that no detection result is available in the position. The prior object detection algorithm adopting computer vision usually relates to the classification of an object into an object class (for example, vehicle), instead of judging whether the object is true positive or false positive.

### SUMMARY OF THE INVENTION

In view of this, the present invention is intended to provide a technical solution for processing object detection results to minimize false positive in detection results. In a first aspect, the present invention provides a processing unit for processing object detection results based on sensor visibilities. The processing unit comprises: an acquisition module, configured to acquire sensor data output when one or more sensors detect an ambient environment, a preprocessing module, configured to calculate a set of detection results based on the acquired sensor data, wherein each detection result contains a detection object and the position information thereof, a creation module, configured to create a visibility map based on the acquired sensor data and the calculated detection results, wherein the visibility map comprises a plurality of grid cells of the ambient environment and the visibility probabilities of the grid cells, an assignment module, configured to assign the confidences of the detection results based on the visibility probabilities of grid cells associated with the detection objects of the detection results in terms of position, and a decision-making module, configured to determine whether to remove the detection results from the set of detection results based on the confidences of the detection results and a threshold predetermined for the set of detection results.

In a second aspect, the present invention provides a processing system for processing object detection results based on sensor visibilities. The processing system comprises a sensing unit, comprising one or more sensors and configured to detect an ambient environment and output sensor data, and the above-mentioned processing unit, configured to create a visibility map containing sensor visibilities, assign a confidence to each detection result based on the visibility map, and determine whether to remove a detection result based on the confidence of the detection result.

In a third aspect, the present invention provides a processing method for processing object detection results based on sensor visibilities. Alternatively, the processing method is executed by the processing unit and/or the processing system. The processing method comprises: acquiring sensor data output when one or more sensors detect an ambient environment, figuring out a set of detection results based on the acquired sensor data, wherein each detection result contains a detection object and the position information thereof, creating a visibility map based on the acquired sensor data and the calculated detection results, wherein the visibility map comprises a plurality of grid cells of the ambient environment and the visibility probabilities of the grid cells, assigning the confidences of the detection results based on the visibility probabilities of grid cells associated with the detection objects of the detection results in terms of position, and determining whether to remove detection results from the set of detection results based on the confidences of the detection results and a threshold predetermined for the set of detection results.

In a fourth aspect, the present invention provides a machine readable storage medium. Executable instructions are stored in the machine readable storage medium, and when the instructions are executed, one or more processors will be allowed to execute the above-mentioned method.

### BRIEF DESCRIPTION OF THE DRAWINGS

A reference to the following detailed description in combination with the drawings will help to understand the described embodiments of the present invention more completely. In all the drawings, the same sign throughout the full text represents the same component.

FIG. 1 is a schematic block diagram of the processing system according to one embodiment of the present invention.

FIG. 2 schematically shows an application scenario where the present invention can be implemented.

FIG. 3 schematically shows a visibility map according to one embodiment of the present invention.

FIG. 4 is a flowchart of the processing procedure according to one embodiment of the present invention.

FIG. 5 schematically shows the principle of operation of the processing unit according to one embodiment of the present invention, wherein a single sensor is configured.

FIG. 6 schematically shows the principle of operation of the processing unit according to one embodiment of the present invention, wherein a plurality of sensors are configured.

FIG. 7 schematically shows the principle of operation of the processing unit according to another embodiment of the present invention, wherein a plurality of sensors are configured.

FIG. 8 schematically shows the principle of operation of the processing unit according to yet another one embodiment of the present invention, wherein a plurality of sensors are configured.

FIG. 9 is a flowchart of the processing method according to one embodiment of the present invention.

### SPECIFIC EMBODIMENTS

Feasible embodiments of the present invention will be described below by referring to the drawings.

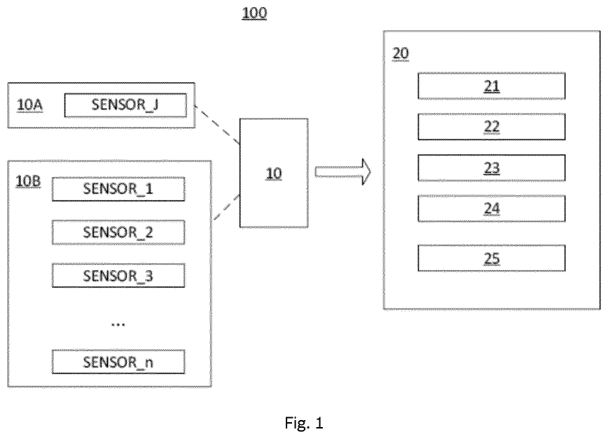

A first aspect of the present invention relates to a processing system for processing object detection results based on sensor visibilities. As shown in FIG. 1, the processing system 100 mainly comprises a sensing unit 10 and a processing unit 20 according to one feasible embodiment of the present invention.

The sensing unit 10 comprises one or more sensors. The one or more sensors are configured to sense an ambient environment and output sensor data. The sensing unit 10 may comprise a single sensor, a plurality of sensors and a plurality of types of sensors.

In one embodiment, the sensing unit 10 is implemented as a single sensor (see SENSOR_J in Block 10A in FIG. 1). The sensor may be a camera, millimeter-wave radar or laser radar.

In one further embodiment, the sensing unit 10 is implemented as a plurality of sensors (see SENSOR_1, SENSOR_2, SENSOR_3, . . . , SENSOR_n in Block 10B in FIG. 1). The sensors may comprise one type or a plurality of types of sensors. For example, the sensing unit 10 comprises a plurality of sensors of the same type and/or a plurality of sensors of different types. For example, the sensing unit 10 may comprise one or more types of the following: camera, millimeter-wave radar and laser radar, and each type of sensor may comprise one or more sensors.

The processing unit 20 is communication-connected with the sensing unit 10. The processing unit 20 calculates detection results, creates a visibility grid map (referred to as visibility map hereinafter) containing sensor visibilities, and evaluates the confidences of the detection results based on the sensor visibilities to improve the quality of the detection results.

In one embodiment, the processing unit 20 may be integrated with the sensing unit 10. For example, the sensing unit 10 and the processing unit 20 are packaged in a casing to constitute a single device.

In a further embodiment, the processing unit 20 and the sensing unit 10 are set up separately. For example, the processing unit 20 may receive sensor data output from the sensing unit over wireless communication. The processing unit 20 may also be placed in a cloud server, and sensor data output from the sensing unit 10 may be uploaded to the cloud server over one or more wireless networks.

See FIG. 1 again. The processing unit 20 may comprise an acquisition module 21, a preprocessing module 22, a creation module 23, an assignment module 24 and a decision-making module 25. The processing unit 20 and the modules thereof may be implemented by use of hardware or software or a combination of both. It may be understood that the processing unit 20 and the modules thereof are named functionally (logically), but not to limit their working modes and physical positions. In other words, they may be placed on the same chip or circuit, or may also be placed on different chips or circuits. The working procedures and principles of operation of the processing unit 20 and the modules will be described later.

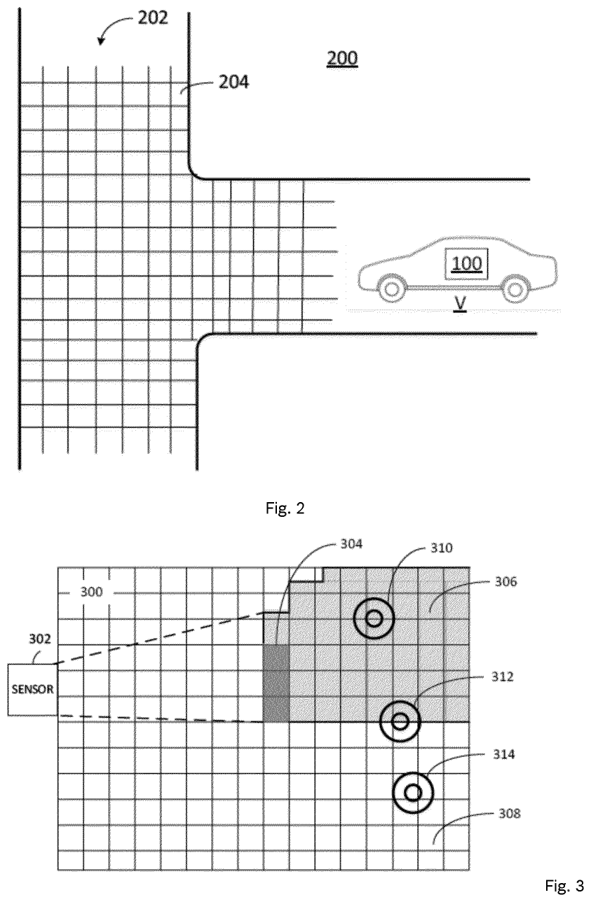

FIG. 2 shows an application scenario of the processing system 100. In the application scenario, the processing system 100 is implemented as a vehicle-mounted system placed on a vehicle V, wherein the sensing unit 10 may be implemented with the aid of the environmental sensors on the vehicle V, and the processing unit 20 may be implemented with the aid of the electronic control unit (ECU) of the vehicle V.

See FIG. 2. The sensing unit 10 senses the environment within the field of view (for example, the environment within the sensing range of vehicle-mounted sensors) and outputs sensor data. The processing unit 20 creates a grid map 202 of the ambient environment based on sensor data and the field of view. The grid map 202 comprises a plurality of grid cells 204. For example, grid cells 204 divide the grid map 202 into equal-size areas according to the Cartesian coordinate system, and thus each grid cell of the grid cells 204 represents a rectangular or square area of the ambient environment. Then, the processing unit 20 creates a visibility map on the grid map 202 and displays the sensor visibilities of the grid cells on the visibility map.

It may be understood that FIG. 2 is only an example of application scenarios of the processing system 100. The processing system 100 may also be applied to a plurality of scenarios/devices/systems/facilities requiring object detections. For example, the processing system 100 may be placed in a monitoring camera, an indoor monitoring system, an outdoor monitoring system or a navigation system.

FIG. 3 schematically shows a visibility map 300 according to one embodiment of the present invention.

See FIG. 3. The dashed lines represents the field of view (FOV) of the sensor 302. The area 304 represents the occupied grid area (for example, the area occupied by an obstacle). The area 304 may comprise one or more grid cells. The area 306 represents an invisible area (for example, an area which is so blocked by an obstacle that the detection lines of the sensor cannot penetrate the area) relative to the detection of the sensor 302. The area 306 may comprise one or more grid cells. The area 308 represents a visible area (for example, a free area neither occupied nor blocked) relative to the detection of the sensor 302.

See FIG. 3 again. The processing unit 20 calculates three objects, namely, object 310, object 312 and object 314, based on the sensor data (for example, raw data output by the sensor 302). Under the occlusion relationship shown in the visibility map 300, the object 310 completely falls into the invisible area 306, the object 312 partially falls into the invisible area 306, and the object 314 completely falls into the visible area 308. In this case, false positive may be marked for the object 310 because the object completely falls into the invisible area relative to the sensor 302.

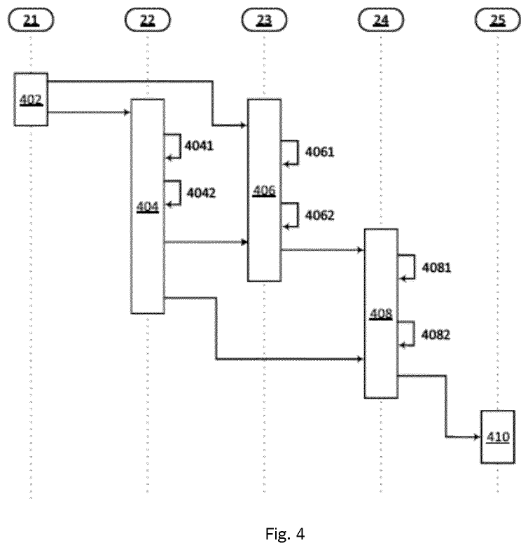

FIG. 4 schematically shows a flowchart of the processing procedure according to one embodiment of the present invention. The processing procedure may be implemented with the aid of the processing unit 20 and/or the processing system 100. Therefore, the descriptions of the processing unit 20 and the processing system 100 are also applicable here.

See FIG. 4. In Block 402, the acquisition module 21 acquires sensor data from one or more sensors of the sensing unit 10. The sensor data may be interpreted as raw data output by sensors. The acquired data comprises real-time updates output when sensors sense an ambient environment. For example, sensors output the changes of sensor positions or the changes of the environment.

In Block 404, the preprocessing module 22 calculates a set of detection results based on the acquired sensor data. The set contains one or more calculated detection results based on sensor data. Each detection result contains a detection object (calculated detection object) and the position information of the detection object.

The calculated detection results are used for creating a visibility map. For example, the calculated detection results are used as an input of the creation module. To improve the quality of the input so as to improve the quality of the visibility map, the detection results may be checked before the detection results are transmitted to the creation module, and thus low-quality detection results are removed (filtered out) from the set and do not participate in the subsequent map creation. Embodiments of checking the calculated detection results are described below.

In one embodiment (see Block 4041), the preprocessing module 22 determines whether to remove detection results by cross-checking detection results detected by different sensors. In this way, detection results with low confidences will not participate in the creation of the visibility map. For example, the preprocessing module 22 performs cross validations between the calculated detection results based on sensor data output from one sensor and the calculated detection results based on sensor data that is output from one or more other sensors. If calculated detection results based on sensor data output from one sensor match at least one of the calculated detection results based on sensor data output from one or more other sensors (for example, the detection results are consistent), the preprocessing module 22 will allow the detection results to participate in the subsequent map creation. If the calculated detection results based on sensor data that is output from one sensor fail to match any of the calculated detection results based on sensor data that is output from one or more other sensors, the preprocessing module 22 will not transmit the detection results to the creation module so as to forbid the detection results to participate in the map creation.

In another embodiment (see Block 4042), the preprocessing module 22 determines whether to remove detection results coming from a sensor according to the state of the sensor. For example, the preprocessing module 22 receives a sensor state signal indicating the state of a sensor. The state signal contains information indicating whether a sensor is degraded. If the preprocessing module 22 receives a sensor state signal indicating that the sensor is degraded, the preprocessing module will not transmit the detection results coming from the sensor (namely, the calculated detection results based on sensor data output from the sensor) to the creation module. In this way, results detected by a degraded sensor can be prevented from participating in the map creation, and thus unreliable detection results can be filtered out in advance.

In Block 406, the creation module 23 creates a visibility map based on the acquired sensor data and the set of calculated detection results. The visibility map comprises a plurality of grid cells of the ambient environment and the visibility probabilities of the grid cells. A visibility probability represents the visibility of a grid cell relative to the sensor detection. The value of a visibility probability may be in the range of 0 to 1. For example, if the visibility probability of a grid cell is 1, the visibility of the grid cell is the best (for example, completely visible relative to the sensor detection). If the visibility probability of a grid cell is 0, the visibility of the grid cell is the worst (for example, completely invisible relative to the sensor detection). The closer the value of the visibility probability is to 1, the higher the visibility is. The closer the value of the visibility probability is to 0, the lower the visibility is. Embodiments of the creation of a visibility map are described below.

In one embodiment (see Block 4061), the creation module 23 may create an occupancy grid map of an ambient environment and create a visibility map based on the occupancy grid map.

In the embodiment, the creation module 23 may determine the occupancy state of each grid cell based on detection objects (namely, the calculated objects) and the positions thereof. Objects in an ambient environment may comprise static objects and/or dynamic objects. When the objects are dynamic, the occupancy state of a grid cell varies with the movement of the objects accordingly. According to the features of sensors, an occupancy grid map may be a 2-D map or may be a 3-D map. For example, a Lidar sensor may provide height information of objects. If height information of objects is acquired, a 3-D occupancy grid map may be created. The occupancy state of a grid cell may be represented in different ways. For example, the creation module 23 may determine which grid cells are occupied by objects and which grid cells are not occupied by objects and are “free”, and use a binary value to represent an occupancy state or non-occupancy state. The creation module 23 may also determine the occupancy probability of a grid cell (namely, the probability of the grid cell being occupied) and represent the occupancy probability by use of a probability value in the range of 0 to 1. For example, if the occupancy probability of a grid cell is 1, the grid cell is in the occupancy state. If the occupancy probability of a grid cell is 0, the grid cell is in the free state (non-occupancy state).

Then, the creation module 23 may determine the sensor visibilities of grid cells based on the occupancy grid map. In other words, the creation module 23 converts the knowledge about occupied areas and non-occupied areas into the expressions of visible areas and invisible areas.

For example, the creation module 23 may adopt the line-of-sight tracking method to determine the areas which the detection lines of a sensor are unable to reach (penetrate) (for example, the occupied or blocked areas), and determine such areas to be invisible areas and mark them as “invisible”. The creation module determines the areas which the detection lines of a sensor can reach (penetrate) to be visible areas and marks them as “visible”.

Then, the creation module 23 may set the visibility probabilities of grid cells in an invisible area to 0 and the visibility probabilities of grid cells in a visible area to 1. The closer to a visible area a grid cell is, the closer to 1 the visibility probability is. The closer to an invisible area a grid cell is, the closer to 0 the visibility probability is.

In addition, the creation module 23 may also combine other information, for example, attributes of sensors and whether a grid cell is located at the edge of the field of view of a sensor, to create a visibility map. The creation module 23 may also create a visibility map with the aid of a graph neural network.

In another embodiment (see Block 4062), the creation module may directly create a visibility map, without any necessity of creating an occupancy grid map in advance.

In the embodiment, the creation module 23 may provide an initial value of the visibility probability for each grid cell in the visibility map. For example, the creation module sets the initial value to an intermediate value 0.5 between 0 and 1. Then, the creation module 23 regulates the initial value dynamically (in real time) according to update information. Update information may contain an update of sensor data (for example, an update of raw data output by the sensor 302 in real time) and/or an update of detection results (for example, new calculated detection results based on an update of sensor data). For example, when each update indicates a grid cell is visible, the creation module regulates the visibility to 1. When each update indicates a grid cell is invisible, the creation module regulates the visibility to 0.

In Block 408, the assignment module 24 assigns a confidence to each detection result based on the created visibility map. The confidence of a detection result represents the degree the detection result is trusted.

For example, the assignment module 24 assigns a confidence to the detection result of an object according to the visibility probability of the grid cell associated with the object in terms of position. The higher the visibility probability of the grid cell is, the higher the confidence of the detection result associated with the grid cell is. In other words, the higher the detectability of a grid cell relative to a sensor is, the more reliable the detection result associated with the grid cell is.

The value of a confidence may be a binary value or continuously-changing value or a discretely-changing value, depending on the user requirement. These types of confidences are used to express the credibility of a detection object in a predefined manner.

In one embodiment (see Block 4081), the position information of an object in a detection result is a position point (for example, x-y coordinates). In this case, the position point (position coordinates) will correspond to a grid cell in the grid map and the visibility probability (visibility value) of the grid cell will be obtained.

In another embodiment (see Block 4082), the position information of an object in a detection result is border information containing the object size. In this case, the visibility probabilities of all grid cells which the border of the object contains (namely, all grid cells which an object covers) are all extracted. The visibility probabilities (namely, a plurality of visibility values) are converted into one value.

The plurality of visibility probabilities may be converted into a single value in different ways, for example, by obtaining the mean value or using other proper conversion ways. The conversion ways are not limited in the present invention.

In the two cases of the above-mentioned embodiment, one visibility probability is finally output (that is, one value is output), and the visibility probability is used to determine the confidence of a detection result. In this way, by determining the confidence according to the visibility probability, the credibility for a calculated detection result can be expressed in an accurate, objective and quantitative way.

In addition, the confidence may be zoomed in and out in other ranges and fused with the confidences of other detection results of sensors.

In Block 410, the decision-making module 25 determines whether to remove the detection result from the set of detection results based on the confidence of the detection result to improve the quality of the set of detection results.

For example, the decision-making module 25 compares the confidence of the detection result with a confidence threshold predetermined for the set of detection results. When the confidence of the detection result is lower than the confidence threshold, the decision-making module removes the detection result from the set of detection results.

In addition, when the confidence of the detection result is lower than the threshold, the detection result is considered false positive and may be labeled as “false positive (FP)”.

It may be understood that the visibility value 0 indicates invisibility and the visibility value 1 indicates visibility in the above-mentioned embodiment. And vice versa. For example, the visibility value 1 indicates invisibility and the visibility value 0 indicates visibility.

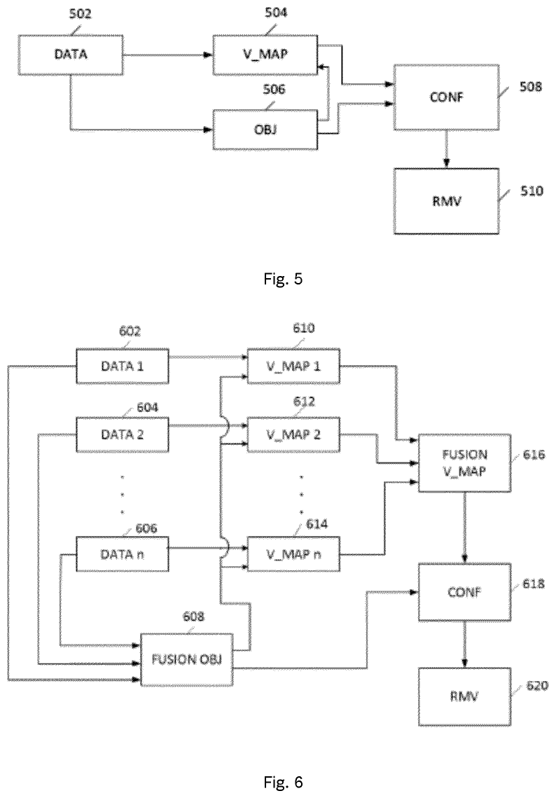

The processing procedure of one embodiment of the present invention has been described above by reference to FIG. 4. The processing procedure in the case of a single sensor will be described below by reference to FIG. 5. The processing procedures in the case of a plurality of sensors will be described below by reference to FIGS. 6 to 8.

See FIG. 5. The acquisition module 21 acquires sensor data DATA output from a single senor when a single sensor detects an ambient environment (Block 502). The preprocessing module 22 calculates a set OBJ of detection results based on the acquired sensor data (Block 504). The creation module 23 creates a visibility map V_MAP based on the acquired sensor data and the set of calculated detection results (Block 506). The assignment module 24 assigns a confidence CONF to each detection result based on the visibility map (Block 508). The decision-making module 25 removes (RMV) a detection result whose confidence is lower than the confidence threshold predetermined for the set from the set (Block 510).

Thus, it can be seen that in the case of a single sensor shown in FIG. 5. the processing unit 20 generates a visibility map for the sensor and evaluates detection results based on the visibility map.

See FIG. 6. The acquisition module 21 acquires sensor data DATA 1, DATA 2, . . . , DATA n output from a plurality of sensors (Blocks 602, 604, 606). The preprocessing module 22 performs fusion processing based on sensor data coming from a plurality of sensors to obtain a fusion set FUSION OBJ of detection results (Block 608). The creation module 23 creates a visibility map for each sensor. For example, the creation module 23 creates a visibility map V_MAP 1 based on sensor data DATA 1 output from a first sensor and the calculated fusion set FUSION OBJ (Block 610), the creation module 23 creates a visibility map V_MAP 2 based on sensor data DATA 2 output from a second sensor and the calculated fusion set FUSION OBJ (Block 612), . . . , and the creation module 23 creates a visibility map V_MAP n based on sensor data DATA n output from an nth sensor and the calculated fusion set FUSION OBJ (Block 614). Then, the creation module 23 creates a fusion visibility map FUSION V_MAP based on the visibility maps for the plurality of sensors (Block 616). The assignment module 24 assigns a confidence CONF to each detection result in the fusion set FUSION OBJ based on the fusion visibility map FUSION V_MAP (Block 618). If the confidence of a detection result is lower than the confidence threshold predetermined for the fusion set, the decision-making module 25 determines to remove (RMV) the detection result from the fusion set (Block 620).

Thus, it can be seen that in the case of a plurality of sensors shown in FIG. 6, the processing unit 20 generates a fusion set of detection results and a fusion visibility map and evaluates the detection results in the fusion set based on the fusion visibility map.

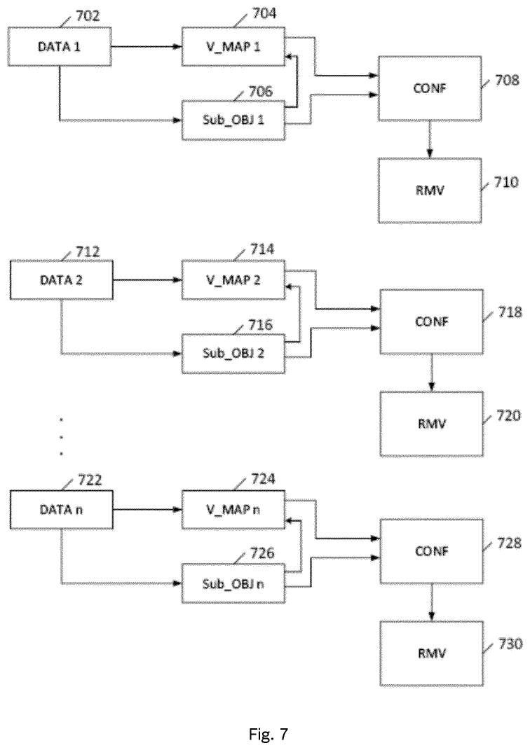

See FIG. 7. The acquisition module 21 acquires sensor data DATA 1, DATA 2, . . . , DATA n output from a plurality of sensors (Blocks 702, 712, 722). The preprocessing module 22 calculates detection results based on sensor data output from a plurality of sensors. For example, the preprocessing module 22 calculates a subset Sub_OBJ 1 of detection results based on sensor data DATA 1 output from a first sensor (Block 706), the preprocessing module 22 calculates a subset Sub_OBJ 2 of detection results based on sensor data DATA 2 output from a second sensor (Block 716), . . . , and the preprocessing module 22 calculates a subset Sub_OBJ n of detection results based on sensor data output from an nth sensor (Block 726). The creation module 23 creates a visibility map for each sensor. For example, the creation module 23 creates a visibility map V_MAP 1 for the first sensor based on sensor data DATA 1 output from the first sensor and the calculated subset Sub_OBJ 1 based on the sensor data (Block 704), the creation module creates a visibility map V-MAP 2 based on sensor data DATA 2 output from the second sensor and the calculated subset Sub_OBJ 2 based on the sensor data (Block 714), . . . , and the creation module creates a visibility map V_MAP n based on sensor data DATA n output from the nth sensor and the calculated object subset Sub_OBJ n based on the sensor data (Block 724). The assignment module 24 assigns a confidence to each detection result in a corresponding subset based on the visibility map of a sensor. For example, the assignment module 24 assigns a confidence to each detection result in the corresponding subset Sub_OBJ 1 based on the visibility map V_MAP 1 of the first sensor (Block 708), the assignment module 24 assigns a confidence to each detection result in the corresponding subset Sub_OBJ 2 based on the visibility map V_MAP 2 of the second sensor (Block 718), . . . , and the assignment module 24 assigns a confidence to each detection result in the corresponding subset Sub_OBJ n based on the visibility map V_MAP n of the nth sensor (Block 728). If the confidence of a detection result is lower than the confidence threshold of the subset of the detection result, the decision-making module 25 determines to remove (RMV) the detection result from the subset. For example, the decision-making module 25 removes (RMV) a detection result whose confidence is lower than the confidence threshold of the first subset Sub_OBJ 1 from the first subset Sub_OBJ 1 (Block 710), the decision-making module 25 removes (RMV) a detection result whose confidence is lower than the confidence threshold of the second subset Sub_OBJ 2 from the second subset Sub_OBJ 2 (Block 720), . . . , and the decision-making module 25 removes (RMV) a detection result whose confidence is lower than the confidence threshold of the nth subset Sub_OBJ n from the nth subset Sub_OBJ n (Block 730).

Thus, it can be seen that in the case of a plurality of sensors shown in FIG. 7, the processing unit 20 generates a subset of detection results of each sensor and a visibility map, and evaluates each detection result in the corresponding subset based on the visibility map of each sensor.

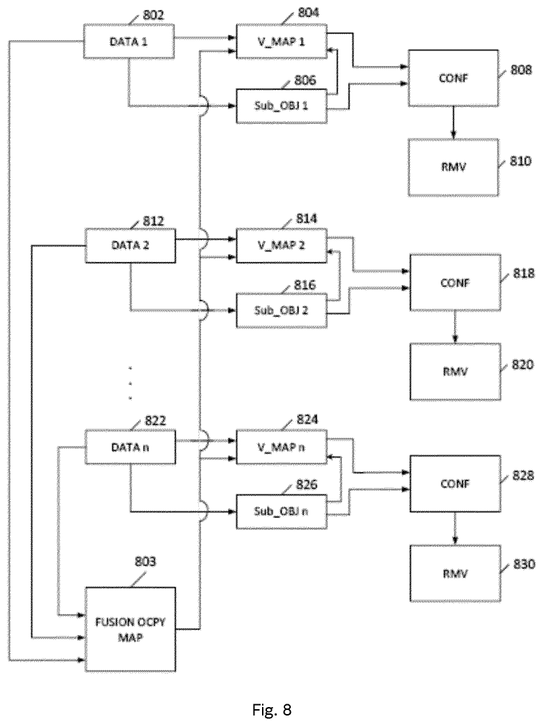

See FIG. 8. The acquisition module 21 acquires sensor data DATA 1, DATA 2, . . . , DATA n output from a plurality of sensors (Blocks 802, 812, 822). The preprocessing module 22 calculates detection results based on sensor data output from a plurality of sensors. For example, the preprocessing module 22 calculates a subset Sub_OBJ 1 of detection results based on sensor data DATA 1 output from a first sensor (Block 806), the preprocessing module 22 calculates a subset Sub_OBJ 2 of detection results based on sensor data DATA 2 output from a second sensor (Block 816), . . . , and the preprocessing module 22 calculates a subset Sub_OBJ n of detection results based on sensor data output from an nth sensor (Block 826). The creation module 23 calculates a fusion occupancy grid map FUSION OCPY MAP based on sensor data output from a plurality of sensors (Block 803). For example, the preprocessing module 22 calculates a fusion set of detection results based on sensor data output from a plurality of sensors, and then the creation module 23 creates a fusion occupancy grid map based on the fusion set. Then, the creation module 23 creates a visibility map for each sensor based on the fusion occupancy grid map. For example, the creation module 23 creates a visibility map V_MAP 1 for the first sensor based on sensor data DATA 1 output from the first sensor, the calculated subset Sub_OBJ 1 based on the sensor data and the fusion occupancy grid map (Block 804), the creation module 23 creates a visibility map V-MAP 2 based on sensor data DATA 2 output from the second sensor, the calculated subset Sub OBJ 2 based on the sensor data and the fusion occupancy grid map (Block 814), . . . , and the creation module creates a visibility map V_MAP n based on sensor data DATA n output from the nth sensor, the calculated object subset Sub_OBJ n based on the sensor data and the fusion occupancy grid map (Block 824). The assignment module 24 assigns a confidence to each detection result in a corresponding subset based on the visibility map of a sensor. For example, the assignment module 24 assigns a confidence to each detection result in the corresponding subset Sub_OBJ 1 based on the visibility map V_MAP 1 of the first sensor (Block 808), the assignment module 24 assigns a confidence to each detection result in the corresponding subset Sub_OBJ 2 based on the visibility map V_MAP 2 of the second sensor (Block 818), . . . , and the assignment module 24 assigns a confidence to each detection result in the corresponding subset Sub_OBJ n based on the visibility map V_MAP n of the nth sensor (Block 828). If the confidence of a detection result is lower than the confidence threshold of the subset of the detection result, the decision-making module 25 determines to remove (RMV) the detection result from the subset. For example, the decision-making module 25 removes (RMV) a detection result whose confidence is lower than the confidence threshold of the first subset Sub_OBJ 1 from the first subset Sub_OBJ 1 (Block 810), the decision-making module 25 removes (RMV) a detection result whose confidence is lower than the confidence threshold of the second subset Sub_OBJ 2 from the second subset Sub_OBJ 2 (Block 820), . . . , and the decision-making module 25 removes (RMV) a detection result whose confidence is lower than the confidence threshold of the nth subset Sub_OBJ n from the nth subset Sub_OBJ n (Block 830).

Thus, it can be seen that in the case of a plurality of sensors shown in FIG. 8, a fusion occupancy grid map is created according to the fusion information coming from a plurality of sensors. The visibility map of each sensor is created separately. In this way, the error of the occupancy grid map used as the basis of a visibility map is more robust to a single sensor.

It may be understood that the embodiments described by reference to FIGS. 5 to 8 are only exemplary, but are not used to limit the scope of the present invention. The present invention further comprises other embodiments in the scope of the present invention.

In another aspect, the present invention relates to a processing method for processing object detection results based on sensor visibilities. The processing method is executed by the above-mentioned processing unit and/or the above-mentioned processing system. Therefore, the descriptions of the processing unit and the processing system are also applicable here.

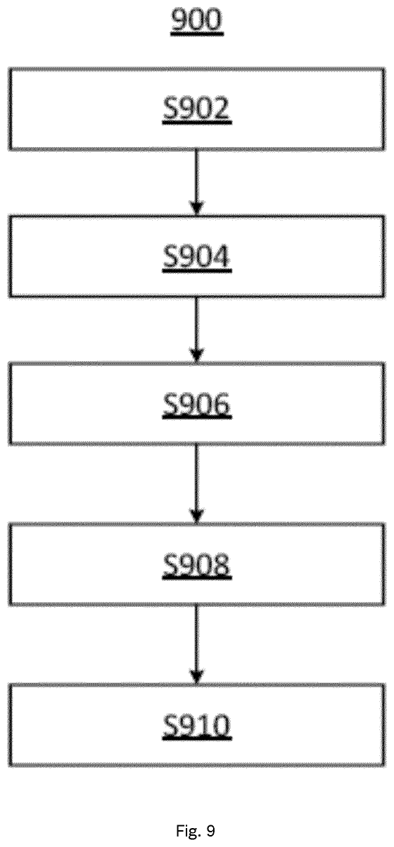

FIG. 9 shows the processing method 900 for processing object detection results based on sensor visibilities according to one embodiment of the present invention.

See FIG. 9. In step 902, sensor data output when one or more sensors detect an ambient environment are acquired.

In step 904, a set of detection results is calculated based on the acquired sensor data, wherein each detection result contains a detection object and the position information thereof.

In step 906, a visibility map is created based on the acquired sensor data and the calculated detection results, wherein the visibility map comprises a plurality of grid cells of the ambient environment and the visibility probabilities of the grid cells.

In step 908, the confidences of the detection results are assigned based on the visibility probabilities of grid cells associated with the detection objects of the detection results in terms of position.

In step 910, it is determined whether to remove detection results from the set of detection results based on the confidences of the detection results and a threshold predetermined for the set of detection results.

The present invention further provides a machine readable storage medium. Executable instructions are stored in the machine readable storage medium. When the instructions are executed, one or more processors will be allowed to execute the above-mentioned sensor data processing method 900.

It may be understood that all modules described above may be implemented in different ways. These modules may be implemented as hardware, software or a combination of hardware and software. In addition, functionally, any of these modules may be further divided into sub-modules or may be combined together.

It may be understood that processors may be implemented as electronic hardware, computer software or any combination thereof. Whether these processors are implemented as hardware or software depends on a specific application and the general design constraints on the system. As an example, a processor, any part of a processor, or any combination of processors given in the present invention may be implemented as a microprocessor, a microcontroller, a digital signal processor (DSP), a field programmable gate array (FPGA), a programmable logic device (PLD), a state machine, a gate logic, a discrete hardware circuit, and any other suitable processing component configured to execute various functions described in the present disclosure. The function of a processor, any part of a processor, or any combination of processors may be implemented as software executed by a microprocessor, microcontroller, a DSP or any other suitable platform.

It may be understood that software should be widely considered to represent instructions, instruction sets, codes, code segments, program codes, programs, sub-programs, software modules, applications, software applications, software packages, routines, sub-routines, objects, running threads, processes, and functions. Software may reside in a computer-readable medium. The computer-readable medium may include a memory, and the memory may be, for example, a magnetic storage device (for example, hard disk, floppy disk and magnetic tape), an optical disk, a smart card, a flash memory device, a random access memory (RAM), a read-only memory (ROM), a programmable ROM (PROM), an erasable PROM (EPROM), an electrically erasable PROM (EEPROM), a register or a removable disk. Although the memory is separated from a processor in various aspects of the present disclosure, the memory may be located inside a processor (for example, buffer or resister).

Although some embodiments are described above, these embodiments are given only as examples but are not intended to limit the scope of the present invention. The attached claims and equivalent replacements thereof are intended to cover all modifications, replacements and changes made without departing from the scope and purpose of the present invention.

1. A processing unit for processing object detection results based on sensor visibilities, comprising:
an acquisition module configured to acquire sensor data output when one or more sensors detect an ambient environment;
a preprocessing module configured to calculate a set of detection results based on the acquired sensor data, wherein each detection result contains a detection object and the position information thereof;
a creation module configured to create a visibility map based on the acquired sensor data and the calculated detection results, wherein the visibility map comprises a plurality of grid cells of the ambient environment and the visibility probabilities of the grid cells;
an assignment module configured to assign the confidences of the detection results based on the visibility probabilities of grid cells associated with the detection objects of the detection results in terms of position; and
a decision-making module configured to determine whether to remove detection results from the set of detection results based on the confidences of the detection results and a threshold predetermined for the set of detection results.

2. The processing unit according to claim 1, wherein if the acquisition module acquires sensor data from two or more sensors:
the preprocessing module is configured to calculate a subset of detection results based on sensor data output from the sensors;
the creation module is configured to create a visibility map based on sensor data output from the sensors and the corresponding subset;
the assignment module is configured to assign confidences to the detection results in the corresponding subset based on the visibility map; and
the decision-making module is configured to determine to remove detection results from the subset when the confidences of detection results in the subset are lower than a threshold predetermined for the subset.

3. The processing unit according to claim 1, wherein if the acquisition module acquires sensor data from two or more sensors:
the preprocessing module is configured to calculate a fusion set of detection results based on sensor data output from the sensors;
the creation module is configured to create a fusion visibility map based on sensor data output from the sensors and the fusion set;
the assignment module is configured to assign confidences to the detection results in the fusion set based on the fusion visibility map; and
the decision-making module is configured to determine to remove detection results from the fusion set when the confidences of detection results in the fusion set are lower than a threshold predetermined for the fusion set.

4. The processing unit according to claim 1, wherein the preprocessing module is further configured to:
perform cross validations between the detection results detected by one sensor and the detection results detected by one or more other sensors;
allow the detection results detected by one sensor to participate in the creation of the visibility map if the detection results detected by one sensor match at least one of the detection results detected by one or more other sensors; and
forbid the detection results detected by one sensor to participate in the creation of the visibility map if the detection results detected by one sensor fail to match any of the detection results detected by one or more other sensors.

5. The processing unit according to claim 1, wherein the preprocessing module is further configured to:
receive a sensor state signal indicating the state of a sensor; and
forbid the detection results detected by one sensor to participate in the creation of the visibility map when receiving a sensor state signal indicating a degraded state of the sensor.

6. The processing unit according to claim 1, wherein the creation module is configured to:
provide an initial value of the visibility probability for each grid cell and regulate the initial value to a higher or lower visibility probability according to an update of sensor data and/or detection results.

7. The processing unit according to claim 1, wherein the creation module is configured to:
create an occupancy grid map, which contains the occupancy state of each grid cell and occlusion relationships between detection objects, based on sensor data or a set of detection results, and determine the visibility probability of each grid cell according to the occupancy grid map.

8. A processing system for processing object detection results based on sensor visibilities, comprising:
a sensing unit comprising one or more sensors and configured to detect an ambient environment and output sensor data; and
the processing unit according to claim 1 which is configured to create a visibility map containing sensor visibilities, assign a confidence to each detection result based on the visibility map, and determine whether to remove a detection result based on the confidence of the detection result.

9. A processing method for processing object detection results based on sensor visibilities, the processing method being executed by the processing unit according to claim 1, and the processing method comprising:
acquiring sensor data output when one or more sensors detect an ambient environment;
figuring out a set of detection results based on the acquired sensor data, wherein each detection result contains a detection object and the position information thereof;
creating a visibility map based on the acquired sensor data and the calculated detection results, wherein the visibility map comprises a plurality of grid cells of the ambient environment and the visibility probabilities of the grid cells;
assigning the confidences of the detection results based on the visibility probabilities of grid cells associated with the detection objects of the detection results in terms of position; and
determining whether to remove detection results from the set of detection results based on the confidences of the detection results and a threshold predetermined for the set of detection results.

10. A machine readable storage medium, storing executable instructions, wherein when the instructions are executed, one or more processors will be allowed to execute the method according to claim 9.
